(19) United States
(12) Patent Application Publication
(10) Pub. No.: US 2016/0203270 A1
(43) Pub. Date: Jul. 14, 2016

(54) COMPREHENSIVE PALLIATIVE AND HOSPICE CARE PLATFORM

(71) Applicants: Edison Sabala, Miami, FL (US); Ingrid Vasiliu-Feltes, Miami, FL (US)

(72) Inventors: Edison Sabala, Miami, FL (US); Ingrid Vasiliu-Feltes, Miami, FL (US)

(21) Appl. No.: 14/986,740

(22) Filed: Jan. 4, 2016

Related U.S. Application Data
(60) Provisional application No. 62/102,286, filed on Jan. 12, 2015.

(51) Int. Cl. G06F 19/00

(52) U.S. Cl. CPC G06F 19/322; G06F 19/325; G06F 19/328

(57) ABSTRACT

A platform and methods for providing comprehensive palliative and hospice services and a cost calculator are described herein. The platform for providing comprehensive palliative and hospice services includes an analytics tool, a business development tool, a coordinating tool, and a performance improvement tool. The analytics tool is configured to evaluate a patient based on eligibility criteria to determine eligibility of the patient for palliative care or hospice care and create electronic alerts based on the evaluation. The business development tool is configured to facilitate obtaining an order for consultations regarding palliative care or hospice care from a primary care provider and facilitate flow of information among healthcare providers. The coordinating tool is configured to facilitate population of patient data and link healthcare providers and interested parties. The performance improvement tool is configured to inform the healthcare providers about the eligibility criteria by a payer or an appropriate level of care.

### TECHNICAL FIELD

The present disclosure relates generally to data processing and, more particularly, to platforms and methods for providing comprehensive palliative and hospice services and a cost calculator for providing comprehensive palliative and hospice services.

### BACKGROUND

According to the statistics, the aging population has increased and a great share of healthcare expenditures is spent on people with multiple chronic diseases. The Centers for Medicare and Medicaid Services (CMS) and private payers of medical services have placed heavy emphasis on population health management and many leading healthcare agencies recognize the importance of palliative and hospice care programs in managing chronic diseases of the growing aging population. A significant percentage of healthcare expenditures is dedicated to post-acute care. A minor part of the population having multiple chronic conditions conventionally accounts for a significant portion of Medicare social insurance program costs. Accumulated evidence consistently shows that a high number of patients, who could benefit from early recognition and engagement as candidates for palliative or hospice care, receive such services too late to survive.

Barriers to early recognition and engagement of the aged into palliative or hospice care include: lack of physician education in palliative and hospice care criteria; poor communication between clinical treatment teams and primary care providers (PCPs); difficulty in obtaining PCP orders for palliative care consults; patient or family lack of knowledge regarding availability of palliative/hospice care services; family refusal; and lack of adequate or scalable technologies, systems, and workflows that identify eligible patients early in the continuum of care. Existing palliative and hospice care models fail to address all of the barriers listed above.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are platforms and methods for providing comprehensive palliative and hospice services and a cost calculator for a comprehensive palliative and hospice care program. The computer-implemented platform for providing comprehensive palliative and hospice services may include an analytics tool, a business development tool, a coordinating tool, and a performance improvement tool.

The analytics tool may be configured to evaluate a patient based on eligibility criteria for a palliative care consult or hospice evaluation or referral. The eligibility may be signaled using electronic flagging within an electronic medical records system. The eligibility may be further signaled by automated reporting to the palliative care or hospice care network or PCPs. The eligibility may be determined based on data from one or more of the following: a national database, retrospective claims analysis, billing data, clinical electronic data, pharmacy data, and laboratory data. The analytics tool may be further configured to create electronic alerts. The electronic alerts may be generated for one or more of the following: emergency rooms (ERs), hospital inpatient units, PCPs, palliative care call centers, palliative care teams, and ambulatory centers, such as cancer ambulatory centers or dialysis ambulatory centers. The electronic alerts may be sent via one or more of the following: automated phone calls, email, Short Message Service (SMS), within the electronic medical record system, and so forth.

The business development tool may be configured to use the information provided by the analytics tool and to facilitate obtaining of an order regarding palliative care or hospice care from a PCP. Additionally, the business development tool may be configured to facilitate flow of information among PCPs, clinical care providers, palliative care providers and hospice care providers.

The coordinating tool may be configured to facilitate population of patient data. The patient data may include demographic data and clinical data obtained from one or more of the following: an electronic medical record (EMR), palliative care data sources, and hospice care data sources. The coordinating tool may be further configured to link a plurality of healthcare providers and interested parties. The plurality of healthcare providers and interested parties may include one or more of the following: an emergency care provider, a clinical care provider, a PCP, a palliative care provider, a hospice care provider, and a family of a patient. The linking may be performed via one or more of the following: automated phone calls, recorded care messages, SMS, email, telemedicine, and telehealth consultations.

The performance improvement tool may be configured to inform the healthcare providers about eligibility criteria by a payer or an appropriate level of care within the palliative and hospice continuum. The performance improvement tool may be further configured to auto-populate required forms. The performance improvement tool may be configured to offer a cost calculator.

### BRIEF DESCRIPTION OF THE DRAWINGS

Embodiments are illustrated by way of example and not limitation in the figures of the accompanying drawings, in which like references indicate similar elements and in which:

FIG. 1 illustrates an environment within which a platform for providing comprehensive palliative and hospice services and a method for providing comprehensive palliative and hospice services can be implemented, in accordance with some embodiments.

FIG. 2 is a block diagram showing various modules of a platform for providing comprehensive palliative and hospice services, in accordance with certain embodiments.

FIG. 3 is a block diagram showing various modules of a cost calculator for a platform for providing comprehensive palliative and hospice services, in accordance with certain embodiments.

FIG. 4 is a flow chart illustrating a method for providing comprehensive palliative and hospice services, in accordance with some example embodiments.

FIG. 5 illustrates operations of the platform for providing comprehensive palliative and hospice care, in accordance with some example embodiments.

FIG. 6 shows an example coordination workflow originated by PCP in the platform for providing comprehensive palliative and hospice services, in accordance with some example embodiments.

FIG. 7 shows an example coordination workflow originated by a hospital in the platform for providing comprehensive palliative and hospice services, in accordance with some example embodiments.

FIG. 8 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The present disclosure aims to address the physician—and process-related challenges by formulating criteria which use an organization's proprietary data, and care coordination platforms that facilitate the ability of clinical teams to recognize eligible patients early, provide the requisite documentation for authorization of services by governmental or private payers, obtain PCP orders and allow comprehensive care coordination between service providers along the care continuum, including clinical team, palliative care and hospice care teams, PCP, home health agencies, payers, and other providers.

The present disclosure provides a platform for providing comprehensive palliative and hospice services, which incorporates predictive analytics, telemedicine, telehealth, electronic rounding and care coordinating tools, electronic alerts and messaging systems, quality improvement measures, and a cost calculator. The platform for providing comprehensive palliative and hospice services may use real-time data and predictive analytics to identify eligible patients for palliative and hospice care as the patients enter the continuum of care. Upon identification of the patients eligible for palliative and hospice care, the platform for providing comprehensive palliative and hospice services may generate electronic alerts via email, text messaging, or otherwise. Moreover, the platform incorporates mandated quality and safety metrics for hospitals and hospices (such as, for example, hospital acquired conditions (HAC), hospital acquired infections (HAI), and the hospital information system (HIS) process measures endorsed by the National Quality Foundation and the National Hospice and Palliative Care Organization) that ensure patients receive the quality care. The platform includes telehealth capability to request or initiate a teleconsultation between a PCP and a patient, among clinical teams, or among clinical teams and patients. The platform uses a cost calculator to assess organization-specific cost savings related to such platform.

Earlier recognition and provision of post-acute palliative or hospice services using the platform described herein may be directly correlated with significant cost-savings and improved patient and/or family satisfaction. With the implementation of comprehensive palliative and hospice care programs, the costs of the Medicare social insurance program may decrease as well as the number of hospital readmissions.

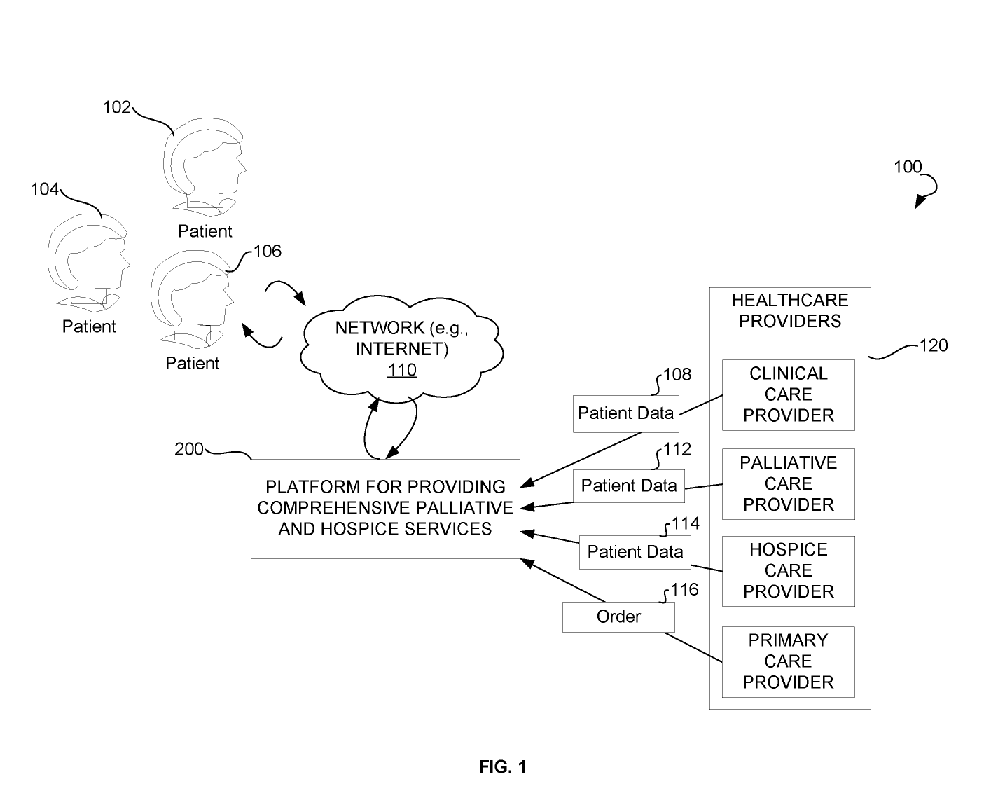

Referring now to the drawings, FIG. 1 illustrates an environment 100 within which a platform for providing comprehensive palliative and hospice services and a method for payment and multimedia capture via a payment and multimedia capture means can be implemented. The environment 100 may include one or more patients 102, 104, 106, network 110, a platform 200 for providing comprehensive palliative and hospice services, and a plurality of healthcare providers 120 (e.g., clinical care provider, palliative care provider, hospice care provider, PCP, and other interested parties). The platform 200 may have a distributed architecture. Various components of the platform 200 may communicate with each other and with the healthcare providers 120, patients 102, 104, 106 and other interested parties via the network 110.

The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking. The patients 102, 104, 106 and personnel of the healthcare providers 120 may interact with the platform via one or more client devices (for example, a smart phone, a laptop, a personal computer (PC), a tablet computer, and so forth).

The platform 200 may receive patient data 108, 112, 114 from the healthcare providers 120. Additionally, the platform may import, store, and periodically update publicly available healthcare data, clinical data, pharmacy data, and so forth from the healthcare providers 120 and other sources. The platform 200 may use a combination of publicly available healthcare data, hospital claims data, hospital or ambulatory feeds from messages for events (such as admission, discharge and transfer (ADT)), and other clinical data to define eligibility criteria that may identify palliative or hospice care eligible patients out of the patients 102, 104, 108 during early stages of decease, or even patients with multiple major comorbidities (for example, >5-8) that are considered high risk within the healthcare system. In an example embodiment, the clinical data includes International Classification of Diseases, Ninth Revision, International Classification of Diseases (ICD) 9/Clinical Modification (CM), DRG, Logical Observation Identifiers Names and Codes (LOINC), Systematized Nomenclature of Medicine (SNOMED), complication or comorbidity (CC)/major complication or comorbidity (MCC) data, pharmacy data, and so forth. Once the eligible patients are identified electronically, the platform 200 generates an automated alert via SMS, email, and/or phone to the PCP and a clinical care team to inform that at least one of the patients 102, 104, 108 is eligible. On receiving the automated alert, personnel of the PCP or the clinical care team can place an order 116 for palliative care evaluation. Once the platform 200 establishes that the eligible patient meets the eligibility criteria and the order 116 for palliative care evaluation is placed, a consultation may be provided to the eligible patient either live or via a telemedicine unit or a telehealth unit. Once the first palliative care consultation has occurred, the platform 200 provides an automated level of care identification, and the patient may be assigned to either follow-up with a palliative care team or engage with the hospice care team.

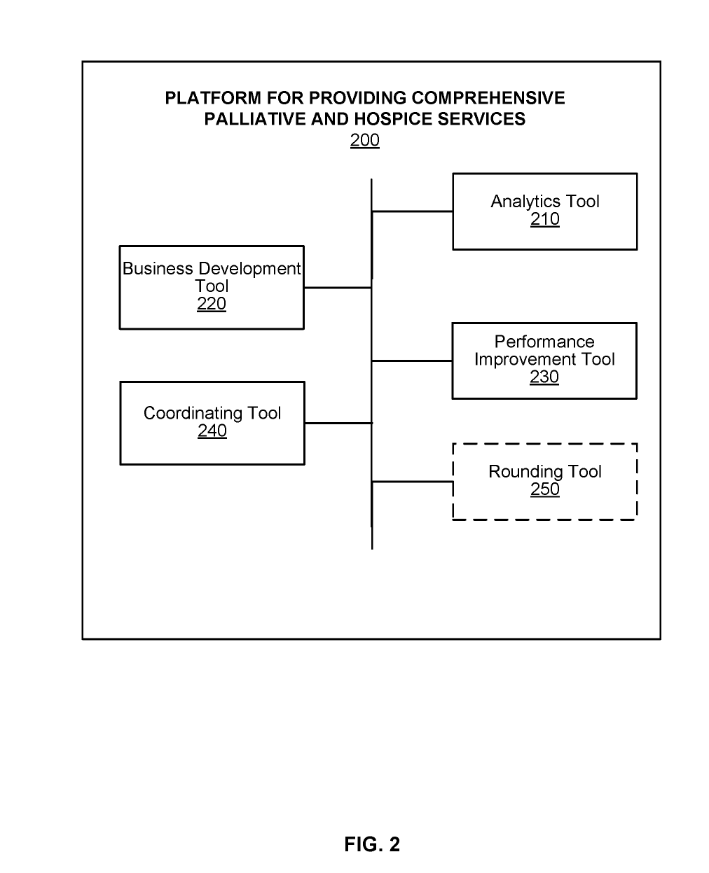

FIG. 2 is a block diagram showing various modules of the platform 200 for providing comprehensive palliative and hospice services, in accordance with certain embodiments. The platform 200 is a data-driven, technology-based platform and may include an analytics tool 210, a business development tool 220, a performance improvement tool 230, and a coordinating tool 240. The modules of the platform 200 may be disposed on one or more shared or dedicated processors and may employ one or more databases.

The analytics tool 210 may be configured to evaluate a patient based on eligibility criteria to determine eligibility of the patient for palliative care or hospice care using real-time data of patients and eligibility factors and predictive analytics. For determination, the analytics tool 210 may use patient data including demographic and clinical data obtained from EMR and from palliative or hospice care data sources. The eligibility may be signaled using electronic flagging within EMR system and/or within other systems. Further, the eligibility may be signaled by automated reporting to a palliative care network, a hospice care network, the PCP, and so forth. The analytics tool 210 may create electronic alerts regarding the eligibility of the patients for palliative care or hospice care. The electronic alerts can be provided to ERs, hospital inpatient units, ambulatory centers, PCPs, palliative care call centers, palliative care teams, and other healthcare providers. In various embodiments, the electronic alerts can be delivered to the healthcare providers via an automated phone call, email message, an SMS, the electronic medical record system, and so forth.

Furthermore, the platform 200 for providing comprehensive palliative and hospice services is designed to serve as the business development tool 220 for any palliative care or hospice program, as the coordinating tool 240 that optimizes clinical team efficiency and links interested parties involved in the post-acute healthcare environment, and as the performance improvement tool 230 that aims to appropriately manage levels of care once patients are enrolled in palliative or hospice care programs. The business development tool 220 may be configured to facilitate obtaining an order for consultations on palliative care or hospice care from a PCP and facilitate flow of information among clinical care providers, palliative care providers, hospice care providers, and so forth. The business development tool 220 may produce an automated daily report to the palliative care or hospice care network or PCPs depending on the customization request. The electronic flagging or the automated report may be produced by using an algorithm, which includes a multitude of variables such as national publicly available datasets, retrospective claims analysis, daily live billing and clinical electronic datasets, pharmacy and laboratory data, and so forth.

The coordinating tool 240 may facilitate the combination of demographic and clinical data that may auto-populate from the EMR and from specific palliative or hospice care data sources. Additionally, the coordinating tool 240 links the clinical ER or hospital teams with the PCPs and with the palliative or hospice care teams as well as with the families of the patients or relevant payers, according to settings specified in the platform 200. The linking occurs via automated phone calls, recorded care messages, SMS, email, and/or telemedicine or telehealth consultations and can be multidirectional. Information may be shared between all members of the clinical treatment and palliative or hospice care teams to optimize efficiency. Care message recording can also ensure an additional level of care to those receiving in-home hospice care. In the event a patient enrolled in palliative or hospice care requires an ER visit, the coordinating tool 240 may generate an automated alert to the PCP and the family.

In some embodiments, the coordinating tool 240 includes an optional rounding tool 250. The rounding tool 250 may be configured to perform administrative rounds, clinical rounds, and so forth using commercially available hardware or software. The rounding tool 250 may be further integrated with the business development tool 220 described above.

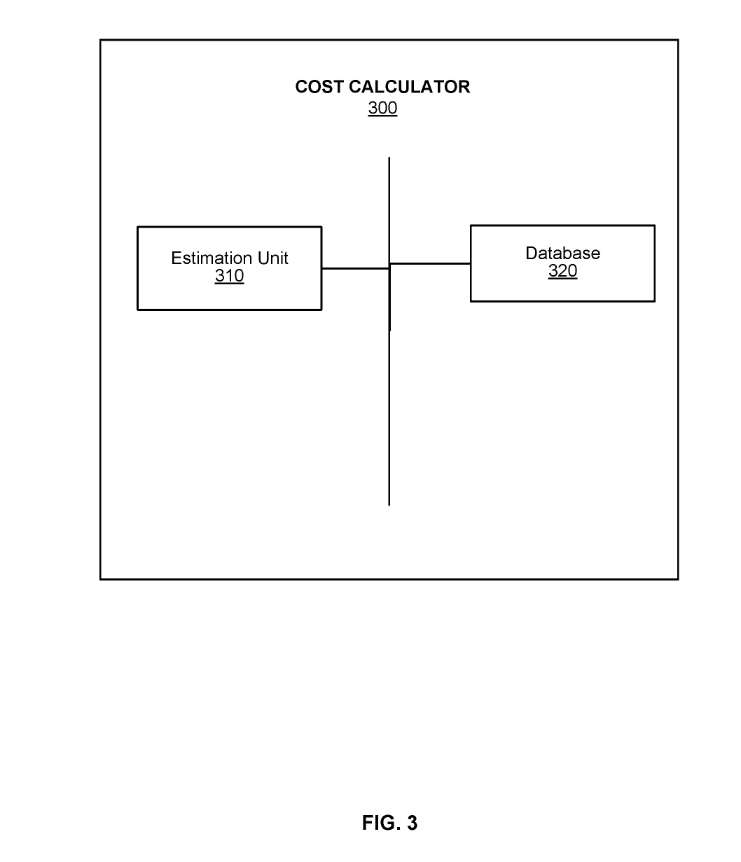

The performance improvement tool 230 may be configured to inform the teams and PCPs about appropriate level of care or eligibility criteria by payer and streamline the documentation process by auto-populating forms and/or blanks associated with palliative and hospice care. Further, the performance improvement tool 230 may monitor quality and safety metrics for the identified eligible patients and provide the monitoring data to personnel of the healthcare provider. In some embodiments, the performance improvement tool 230 offers a cost calculator described with reference to FIG. 3 below.

Furthermore, the platform 200 for providing comprehensive palliative and hospice services may increase referrals to palliative and hospice care programs, improve outcomes, and reduce healthcare expenditures. Thus, certain barriers that prevent eligible patients from being enrolled in palliative care or hospice care programs in a timely manner can be addressed. As the business development tool 220, the platform may assist physicians and nurses with having eligibility criteria readily available as part of their daily clinical workflows, facilitate the process of obtaining a PCP order in a timely fashion, streamline multidirectional information flow among the clinical and palliative or hospice care teams, and enhance the ability to link multidisciplinary teams with patients and families.

FIG. 3 is a block diagram showing various modules of a cost calculator 300 for platform 200 for providing comprehensive palliative and hospice services, in accordance with certain embodiments. The cost calculator 300 may comprise an estimation unit 310 and a database 320. The estimation unit 310 may be configured to import public data from various sources. The public data may include retrospective data related to quality, safety, and finance from CMS, CMS updated fee schedules by state, data of a value-based purchasing calculator, data of a value-based payment modifier calculator from CMS or American Hospital Association (AHA), clinical patient-specific data (ICD 9/CM, DRG, LOINC, SNOMED, CC/MCC data), and data of official guidelines for disease coding and reporting from CMS or AHA. The public data may be stored in the database 320.

The estimation unit 310 may be further configured to receive the one or more metrics related to enrollment of eligible patients in one or more palliative or hospice care programs from an operator (e.g. from personnel of hospice care or clinical teams). Based on the metrics selected by the operator, the estimation unit 310 may estimate an amount of savings per day or another period generated from enrollment of eligible patients in a palliative or hospice care program. Additionally, the estimation unit 310 may be configured to assess the cost savings by transitioning patients enrolled in a certain level of hospice care to an alternative level of care based on a request from the operator. The levels of care may include continuous home care, routine homecare, respite care, general inpatient care, and so forth.

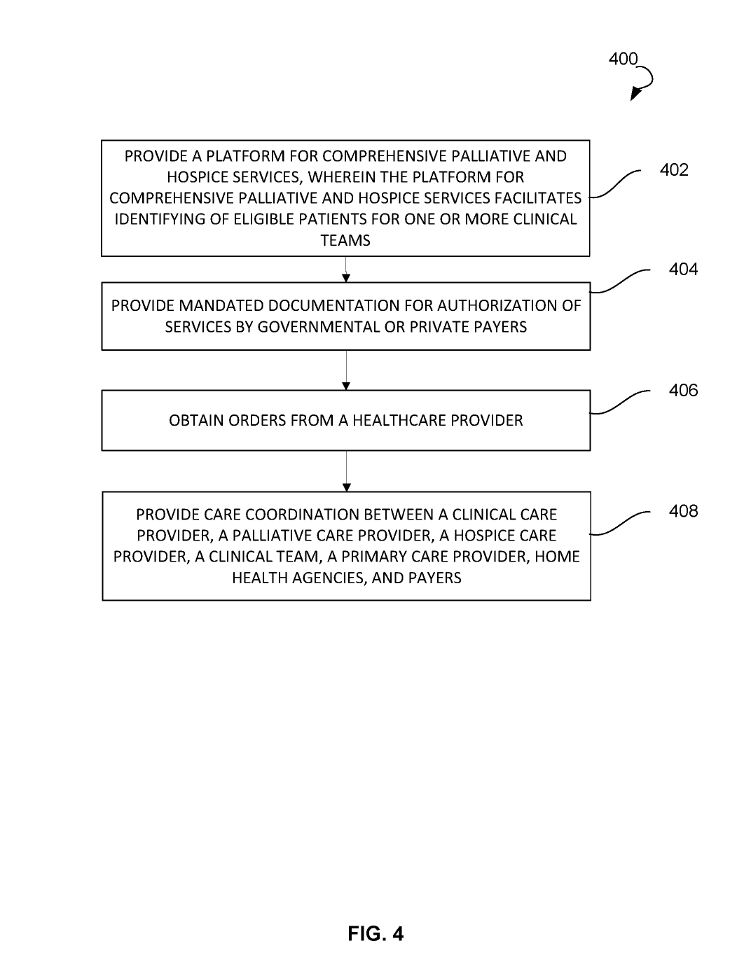

FIG. 4 is a flow chart illustrating a method 400 for providing comprehensive palliative and hospice services, in accordance with some example embodiments. The method may commence at operation 402 with providing a platform for comprehensive palliative and hospice services. The platform may be operable to identify eligible patients for one or more healthcare providers (e.g., clinical teams or PCP) using predetermined criteria and healthcare data, clinical data, pharmacy data, and other data. Based on the identification, an electronic alert may be generated and provided to the healthcare provider via SMS, email, a telephone call, and so forth. The electronic alert may comprise a notification that a patient meets predetermined criteria of eligibility for the palliative care or hospice care.

At operation 404, mandated documentation for authorization of services related to hospice care or palliative care by governmental payers or private payers may be provided.

At operation 406, one or more orders for evaluation of hospice care or palliative care may be obtained from a healthcare provider (for example, a PCP or clinic team). After obtaining the order, consultations regarding the hospice care or palliative care may be provided to the eligible patients and/or other interested parties. The consultation can be provided either live or via a telemedicine or telehealth component of the platform 200. Further, the eligible patients may be automatically assigned to a palliative care team or a hospice care team.

Additionally, the method 400 may include providing care coordination between a clinical care provider, a palliative care provider, a hospice care provider, a clinical team, the PCP, home health agencies, and payers at operation 408. Multidirectional electronic alerts may be provided to members of a clinical treatment team, a palliative care team, and a hospice care team and information may be shared between them. Specifically, electronic alerts may be generated to the PCP or family members when the patient requires an ER visit. Furthermore, the method may include providing care message to the eligible patient, healthcare provider, and/or interested parties. The care message may include customized care plan instructions to a PCP, patient, or family members. Additionally, the method may include monitoring mandated quality and safety metrics for the eligible patients identified in the platform 200.

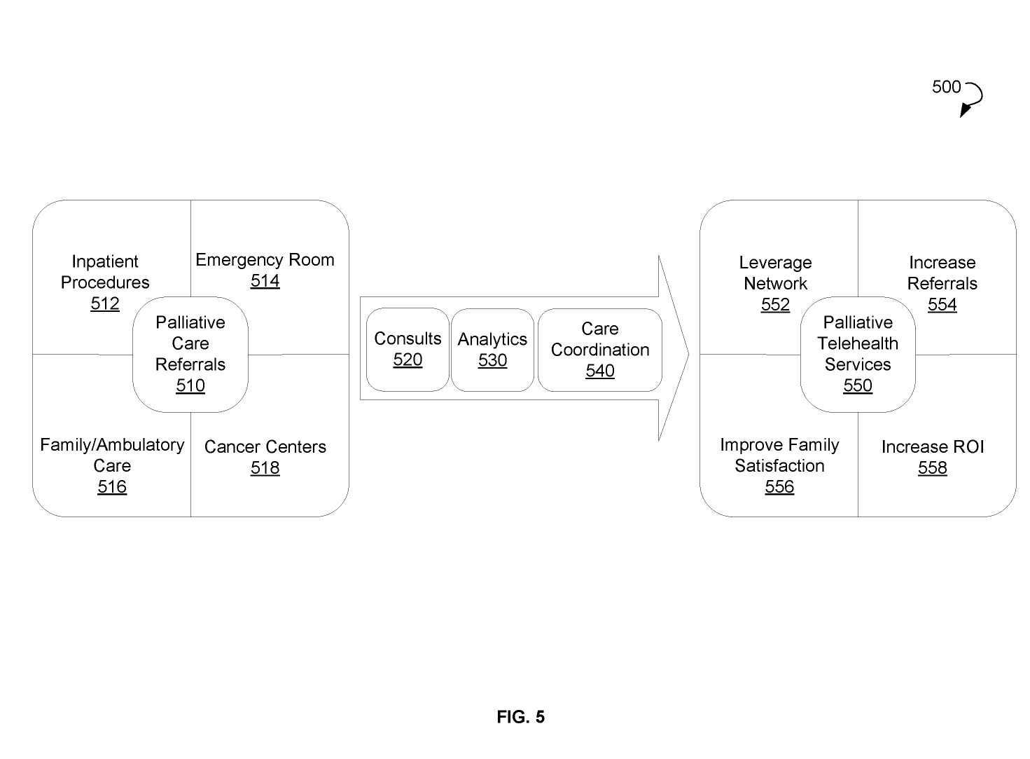

FIG. 5 illustrates operation 500 of the platform 200 for providing comprehensive palliative and hospice care, in accordance with some example embodiments. The platform may identify eligible cases early based on information from inpatient procedures 512, emergency rooms 514, family/ambulatory care 516, or cancer centers 518, and increase the number of appropriate palliative care referrals 510 by offering consultations 520, analytics 530, and care coordination 540. This can either be via logic that creates electronic flags within the electronic medical records system of the healthcare system or by producing an automated daily report to the palliative care or hospice care network or PCPs depending on the customization request. The electronic flagging or the automated report may be produced by using the mathematical algorithm, which includes a multitude of variables, such as national publicly available datasets, retrospective claims analysis, daily live billing and clinical electronic datasets, pharmacy and laboratory data, and so forth.

The consultations 520, analytics 530, and care coordination 540 may be provided via palliative telehealth services 550. Due to the use of the platform 200, the network of palliative and hospice care may be leveraged 552, the number of referrals may increase 554, family satisfaction may improve 556, and return on income (ROI) 558 may increase.

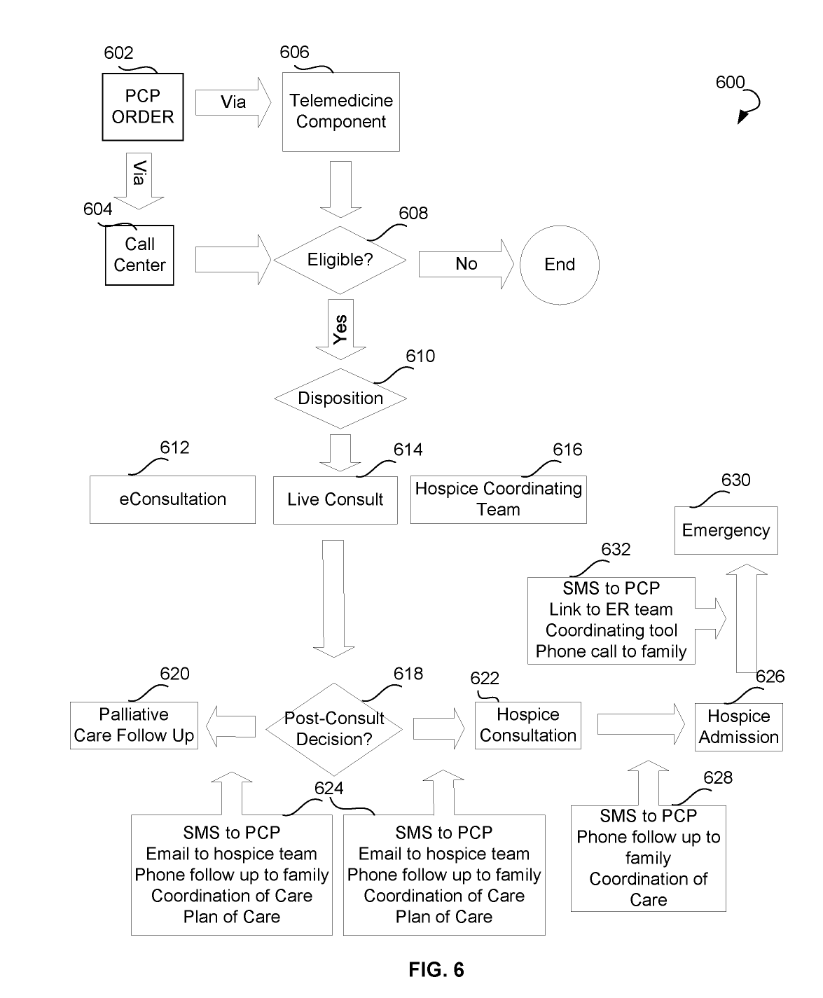

FIG. 6 shows an example coordination workflow 600 originated by PCP in the platform 200 for providing comprehensive palliative and hospice services, in accordance with some example embodiments. A PCP order 602 may be placed via a call center 604 or a telemedicine component 606 of the platform 200. The platform 200 may check if a patient associated with the PCP order 602 is eligible 608 for palliative or hospice care. If the patient is eligible, disposition 610 of the PCP order 602 for eConsultation 612, live consultation 614, or hospice coordinating team 616 may be performed. If the patient is not eligible, the workflow 600 may end.

After the consultation, a post-consultation decision 618 may be made. Based on the decision, the eligible patient may be assigned for palliative care follow up 620 or hospice consultation 622. The platform informs all involved parties about the decision and performs coordination of care. The coordinating tool may link the clinical ER or hospital teams with the PCPs and with the palliative or hospice care teams, as well as with the families of the patients or relevant payers depending on the customization request for the platform. This may occur via automated phone calls, recorded care messages, SMS, email, and telemedicine or telehealth consultations, and may be multidirectional. For example, the platform 200 may send an SMS to PCP, email to hospice team, make a phone follow up to family, and prepare coordination and plan of care 624. Further, after the hospice consultation 622, a hospice admission 626 may be granted and the platform 200 may send an SMS to PCP, make a phone follow up to the family, and prepare coordination of care 628. If the patient is moved to an emergency room 630 from a hospice institution, the platform may also inform the involved parties and take coordination measures 632 (e.g., send SMS to PCP, link to ER team, and so forth).

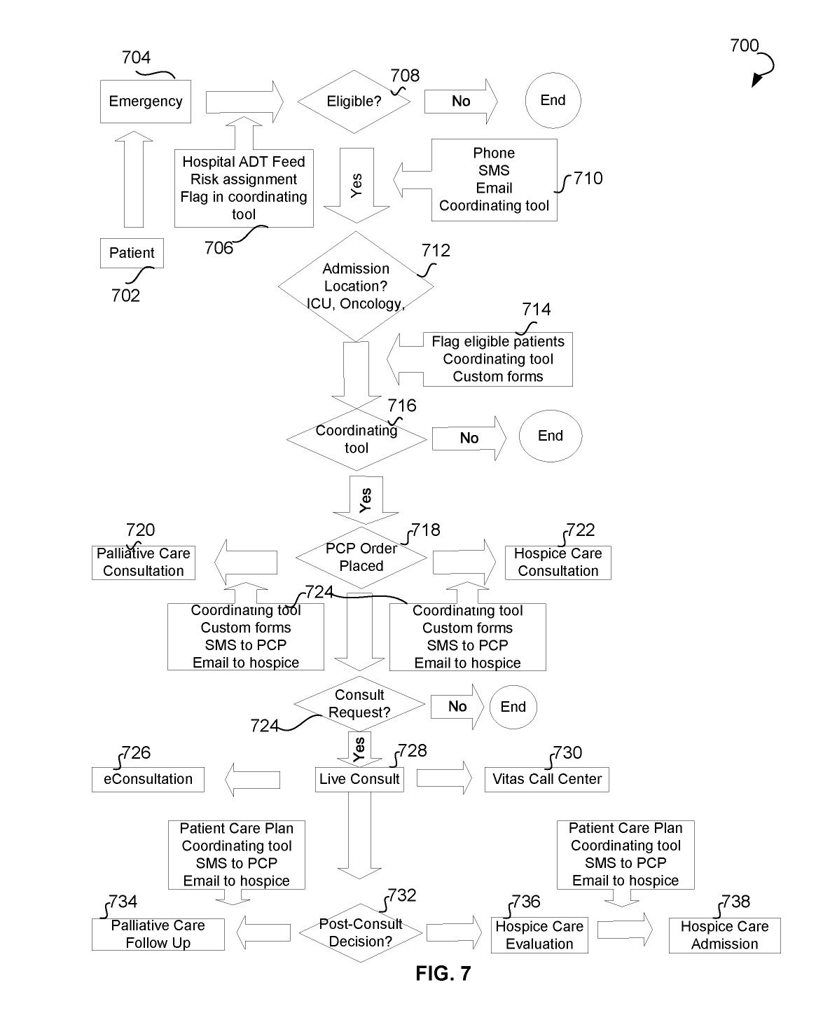

FIG. 7 shows an example coordination workflow 700 originated by a hospital in the platform 200 for providing comprehensive palliative and hospice services, in accordance with some example embodiments. When a patient 702 enters an emergency room 704, the platform 200 may receive an ADT feed including patient data and data on risk assignment and flag the patient 702 in the coordinating tool 706. Using the received patient data and other data, eligibility of the patient 702 may be identified 708. If the patient 702 is not eligible for palliative and hospice care, the workflow 700 may end. However, if the patient 702 is eligible for palliative or hospice care, the platform 200 may inform the interested parties via phone, SMS, email, or coordinating tool 710. Further, admission location of the patient 702 may be determined 712 (e.g., intensive care unit (ICU), oncology, and so forth). The platform may flag eligible patients for personnel of a clinic team or PCP, take coordination measures, and/or provide and auto-populate custom forms 714. A coordinating tool 716 may obtain a PCP order placed 718 and assign the patient 702 for a palliative care consultation 720 or hospice care consultation 722. If no PCP order is placed, the workflow 700 may end.

After the PCP order is placed 718, a palliative care consultation 720 or a hospice care consultation 722 may be provided. For consultation, the platform 200 may take coordination measures via the coordinating tool, provide and auto-populate custom forms, send SMS to PCP, email to the hospital, and so forth.

Further, a consultation request may be received 724. If no consultation request is received, the workflow 700 may end. On receiving the consultation request, eConsultation 726, live consultation 728, or a phone consultation (e.g. via Vitas Call Center) 730 may be provided. After the consultation, a post-consultation decision 732 may be taken. Based on the decision, the patient 702 may be assigned for palliative care follow up 734 or for hospice care evaluation 736 and hospice care admission 738 with corresponding informing and coordination via automated phone calls, recorded care messages, SMS, email, telemedicine or telehealth consultations and may be multidirectional.

By using predictive analytics, a coordinating tool, telemedicine and telehealth capabilities, a cost calculator, an automated level of care identification, auto-populated medical authorization forms, SMS, email and phone messaging, recorded care messages for patients, and so forth, the platform 200 of the present disclosure provides an approach to achieve optimal efficiency, cost reduction for stakeholders, reduce suffering for patients, and decrease the burden of the aged and diseased on their families.

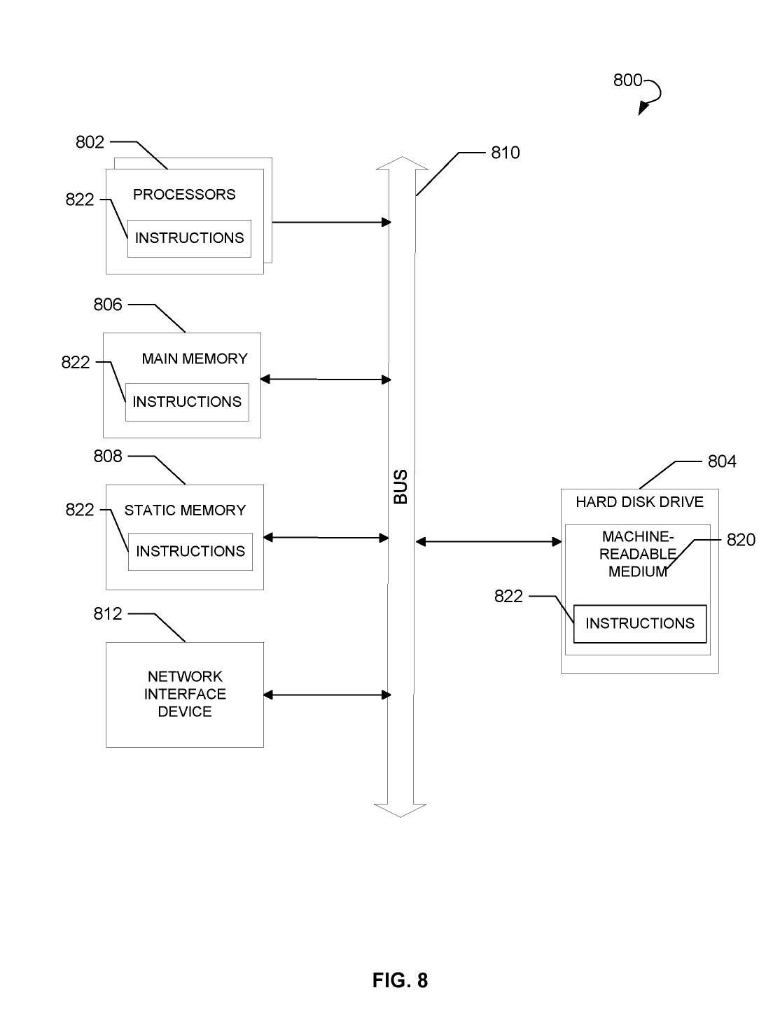

FIG. 8 shows a diagrammatic representation of a computing device for a machine in the exemplary electronic form of a computer system 800, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box (STB), a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor or multiple processors 802, a hard disk drive 804, a main memory 806, and a static memory 808, which communicate with each other via a bus 810. The computer system 800 may also include a network interface device 812. The hard disk drive 804 may include a computer-readable medium 820, which stores one or more sets of instructions 822 embodying or utilized by any one or more of the methodologies or functions described herein. The instructions 822 can also reside, completely or at least partially, within the main memory 806 and/or within the processors 802 during execution thereof by the computer system 800. The main memory 806 and the processors 802 also constitute machine-readable media.

While the computer-readable medium 820 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, RAM, ROM, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, C++, C# or other compilers, assemblers, interpreters or other computer languages or platforms.

In some embodiments, the computer system 800 may be implemented as a cloud-based computing environment, such as a virtual machine operating within a computing cloud. In other embodiments, the computer system 800 may itself include a cloud-based computing environment, where the functionalities of the computer system 800 are executed in a distributed fashion. Thus, the computer system 800, when configured as a computing cloud, may include pluralities of computing devices in various forms, as will be described in greater detail below.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The corresponding structures, materials, acts, and equivalents of all means or steps plus function elements in the claims below are intended to include any structure, material, or act for performing the function in combination with other claimed elements as specifically claimed. The description of the present technology has been presented for purposes of illustration and description, but is not intended to be exhaustive or limited to the disclosure. Many modifications and variations will be apparent to those of ordinary skill in the art without departing from the scope and spirit of the disclosure. Exemplary embodiments were chosen and described in order to best explain the principles of the present technology and its practical application, and to enable others of ordinary skill in the art to understand the disclosure for various embodiments with various modifications as are suited to the particular use contemplated.

Aspects of the present technology are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Thus, a platform for providing comprehensive palliative and hospice services, a cost calculator, and a method for providing comprehensive palliative and hospice services are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A computer-implemented platform for providing comprehensive palliative and hospice services, the platform comprising:
an analytics tool to:
evaluate a patient based on eligibility criteria to determine an eligibility of the patient for palliative care or hospice care; and
create electronic alerts based on the evaluation;
a business development tool to:
facilitate obtaining an order for consultations regarding palliative care or hospice care from a primary care provider (PCP); and
facilitate flow of information among clinical care providers, palliative care providers, and hospice care providers;
a coordinating tool to:
facilitate population of patient data; and
link a plurality of healthcare providers and interested parties;
a performance improvement tool to:
inform the plurality of healthcare providers about the eligibility criteria by a payer or an appropriate level of care;
auto-populate at least one form with the patient data;
monitor mandated quality and safety metrics for identified eligible patients; and
offer a cost calculator.

2. The computer-implemented platform of claim 1, wherein the patient data includes demographic and clinical data obtained from an electronic medical record (EMR) and from palliative or hospice care data sources.

3. The computer-implemented platform of claim 1, wherein the plurality of health providers and interested parties includes one or more of the following: an emergency care provider, a clinical care provider, the PCP, a palliative care provider, a hospice care provider, and a family of the patient.

4. The computer-implemented platform of claim 1, wherein the linking is performed via one or more of the following: automated phone calls, recorded care messages, short message service (SMS), email, telemedicine, and telehealth consultations.

5. The computer-implemented platform of claim 1, wherein the eligibility is signaled using electronic flagging within an electronic medical records system.

6. The computer-implemented platform of claim 1, wherein the eligibility is signaled by automated reporting to one or more of the following: a palliative care network, a hospice care network, and the PCP.

7. The computer-implemented platform of claim 1, wherein the eligibility is determined based on one or more of the following: data from a national database, a retrospective claims analysis, billing data, clinical electronic data, pharmacy data, and laboratory data.

8. The computer-implemented platform of claim 1, wherein the electronic alerts are provided to one or more of the following: emergency rooms (ERs), hospital inpatient units, ambulatory centers, PCPs, palliative care call centers, and palliative care teams.

9. The computer-implemented platform of claim 1, wherein the electronic alerts are provided via one or more of the following: an automated phone call, email message, an SMS, and an electronic medical record system.

10. A cost calculator for a platform for providing comprehensive palliative and hospice services, the cost calculator comprising:
an estimation unit configured to:
import public data from multiple sources; and
estimate, using one or more metrics, an amount of savings generated from enrollment of eligible patients in one or more palliative or hospice care programs using predetermined criteria; and
a database configured to store at least the public data.

11. The cost calculator of claim 10, wherein the public data includes one or more of the following: quality data, safety data, financial data, updated fee schedules by state, data of a value-based purchasing calculator, data from a value-based payment modifier calculator, clinical patient-specific data, and data of official guidelines for disease coding and reporting.

12. The cost calculator of claim 10, wherein the estimation unit is further configured to receive, from an operator, the one or more metrics related to the enrollment of the eligible patients in one or more palliative or hospice care programs.

13. The cost calculator of claim 10, wherein the estimation unit is further configured to assess cost savings associated with transitioning of a patient enrolled in palliative or hospice care program to an alternative palliative or hospice care program.

14. A method for providing comprehensive palliative and hospice services, the method comprising:
providing a platform for comprehensive palliative and hospice services, wherein the platform is operable to identify eligible patients for palliative care or hospice care;
providing mandated documentation for authorization of services by governmental payers or private payers;
obtaining one or more orders from a healthcare provider; and
providing care coordination between a clinical care provider, a palliative care provider, a hospice care provider, a clinical team, a primary care provider (PCP), home health agencies, and payers.

15. The method of claim 14, wherein the identification of the eligible patients for palliative care or hospice care is based on predetermined criteria and one or more of the following: healthcare data, clinical data, and pharmacy data.

16. The method of claim 14, further comprising generating, based on the identification, an electronic alert at least to the healthcare provider, the electronic alert including one or more of the following: an SMS, an email, and a telephone call and comprising a notification that a patient meets predetermined criteria of eligibility for the palliative care or hospice care.

17. The method of claim 14, wherein the healthcare provider includes the PCP and a clinical care team.

18. The method of claim 14, further comprising providing consultations to the eligible patients, wherein the consultations are live or provided via one or more of the following: a telemedicine component and a telehealth component.

19. The method of claim 14, further comprising automatically assigning the eligible patients to a palliative care team or a hospice care team.

20. The method of claim 14, further comprising providing multidirectional electronic alerts and information sharing between members of the one or more clinical teams, a palliative care team, and a hospice care team.
